(19) United States
(12) Patent Application Publication
(10) Pub. No.: US 2008/0075803 A1
(43) Pub. Date: Mar. 27, 2008

(54) Food

(75) Inventor: Katsuhisa Honda, Matsuyama-shi (JP)

Correspondence Address: BIRCH STEWART KOLASCH & BIRCH, PO BOX 747, FALLS CHURCH, VA, 22040-0747, US

(73) Assignee: Miura Co., Ltd.

(21) Appl. No.: 11/892,119

(22) Filed: Aug. 20, 2007

(30) Foreign Application Priority Data
Sep. 25, 2006 (JP) 2006-258200
Jun. 14, 2007 (JP) 2007-157090

(51) Int. Cl. A23K 1/16; A23K 1/18; A23L 1/00; A23L 1/015; B01J 20/20

(52) U.S. Cl. 426/2; 119/230; 119/242; 426/531; 502/416

(57) ABSTRACT

Provides is a food having an increased effect of inhibiting accumulation of polychlorinated biphenyls in a living body contains a carbonaceous material that has a pore structure capable of exhibiting adsorbability and to which calcium is bound. The carbonaceous material used herein usually has an average pore diameter of 0.70 to 0.90 nm and a specific surface area of 950 to 1,600 m²/g. The food can adsorb dioxins inclusive of polychlorinated biphenyls that are contained in the food or accumulated in the living body by the carbonaceous material. The carbonaceous material contained in the food, after being taken in, can be excreted from the living body together with the excrement.

### BACKGROUND OF THE INVENTION

1. Field of the Invention

The present invention relates to a food, and more particularly, to a food containing a carbonaceous material.

2. Description of the Related Art

In the market of edible fishes, a large amount of various cultured fishes such as bream and young yellowtail are supplied owing to developments of aquaculture technologies. For some fishes, market shares of the cultured fishes significantly exceed that of natural fishes.

Incidentally, in the aquaculture of edible fishes, feed is positively fed to the fishes starting from a stage where it is a fry. The feed used in the stage is usually minced meat or fish meal prepared from fish and shellfish materials such as sardines, or mixtures of those with fish oil and various additives. Because the fish and shellfish materials contain a trace amount of dioxins, such feeds naturally contain a trace amount of dioxins deriving from grown the fish and shellfish materials. As a result, in the cultured fishes that have grown on such feed, the dioxins contained in the feed might be concentrated and accumulated in the body due to biological concentration. Dioxins, as stipulated in the Japan Special Measure against Dioxins (Law No. 105, 1999), is a generic name for polychlorodibenzo-para-dioxins (PCDDs), polychlorodibenzofurans (PCDFs), and polychlorinated biphenyls (PCBs) (in particular, coplanar polychlorinated biphenyls (Co-PCBs)). They show effects as environmental hormones, so if the cultured fishes that accumulate therein the environmental hormones are taken as a food continuously for a long period of time, adverse effects on the human body will be concerned about.

Accordingly, a food that contains a carbonaceous material capable of adsorbing dioxins such as carbon black, activated carbon, and graphite has been proposed by the applicants (International Patent WO 2005/039312). The carbonaceous material contained in the food can adsorb dioxins contained in the food in a trace amount and is excreted from the living body that took the food together with the excrement. Therefore, contents of dioxins of domestic animals, and cultured fishes and shellfishes supplied with the food can have considerably reduced as compared with those of domestic animals, and cultured fishes and shellfishes supplied with usual feed.

However, the carbonaceous material used in the food has a poorer adsorbability for PCBs than for PCDDs and PCDFs, so accumulation of the PCBs in the living body cannot be sufficiently prevented.

### SUMMARY OF THE INVENTION

Therefore, an object of the present invention is to increase an effect of preventing accumulation of PCBs in the living body.

The food of the present invention contains a carbonaceous material that has a pore structure capable of exhibiting adsorbability and to which calcium is bound. The food can adsorb dioxins contained in food or those accumulated in the living body with the contained carbonaceous material. In particular, the carbonaceous material used herein has calcium bound thereto, so it is excellent in adsorbability not only for PCDDs and PCDFs but also for PCBs. Further, the carbonaceous material contained in food, after being taken in, can be excreted together with the excrement from the living body. Therefore, the food can effectively prevent accumulation of dioxins inclusive of PCBs in the living body that has taken the food.

The carbonaceous material used in the food, for example, preferably has an average pore diameter of 0.70 to 0.90 nm and a specific surface area of 950 to 1,600 m²/g. Use of such a carbonaceous material enables more effective inhibition of accumulation of dioxins, in particular, PCBs, in the living body.

The food of the present invention can be used in, for example, cultivation of fish and shellfish, breeding of poultry or domestic animals. The method of cultivating fishes and shellfishes according to the present invention includes a process of feeding a food containing a carbonaceous material that has a pore structure capable of exhibiting adsorbability and to which calcium is bound to fishes and shellfishes. The method of breeding poultry according to the present invention includes a process of feeding a food containing a carbonaceous material that has a pore structure capable of exhibiting adsorbability and to which calcium is bound to poultry. Further, the method of breeding domestic animals according to the present invention includes a process of feeding a food containing a carbonaceous material that has a pore structure capable of exhibiting adsorbability and to which calcium is bound to domestic animals.

The methods according to the present invention can effectively prevent accumulation of dioxins inclusive of PCBs in the body of cultured fishes and shellfishes, or bred poultry or domestic animals because the food of the present invention is fed. Therefore, the fishes and shellfishes, or poultry or domestic animals cultured or bred by the methods of the present invention can be supplied as safe food for humans.

Other objects and effects of the present invention are mentioned in the following detailed description of the invention.

### DETAILED DESCRIPTION OF THE PREFERRED EMBODIMENTS

The food of the present invention is of a concept including not only food for humans but also feed for use for cultivating or breeding poultry such as chicken, wild duck, pigeon, quail, and duck, domestic animals such as dog, cat, pig, horse, rabbit, deer, and cattle, fish and shellfish, and other animals.

The food of the present invention is a so-called processed food composed mainly of a foodstuff and a carbonaceous material. The foodstuff used herein is one edible to animals inclusive of humans, that is, the foodstuff that animals take in for their living and nourishment. The food may be either of plant origin or of animal origin. The food may be either of natural food or processed food. Preferably, the food is in the form capable of being uniformly mixed with the carbonaceous material and may be any one of a solid form, such as in a powder, cut, or minced form, a liquid form, or a jelly form.

On the other hand, the carbonaceous material contained in the food of the present invention has calcium bound thereto. The carbonaceous material to which calcium is bound is a material composed substantially of carbon having a pore structure capable of adsorbing various compounds as a result of activation treatment, for example, activation treatment with steam. Examples of the carbonaceous material include carbon black, activated carbon, and graphite as well as any desired mixtures thereof.

The shape of the carbonaceous material is not particularly limited, but preferably is in the form of powder, granule, or minute fiber that is easy to be uniformly mixed with food. The carbonaceous material may be a mixture of such various forms.

The carbonaceous material is preferably one that is characterized by the pore structure having a specified average pore diameter and a specific surface area. Specifically, the carbonaceous material has an average pore diameter, preferably slightly greater than the size of the molecule of PCBs, that is, 0.70 to 0.90 nm, and more preferably 0.70 to 0.85 nm. The carbonaceous material has a specific surface area of preferably 9.50 to 1,600 m²/g, and more preferably 980 to 1,400 m²/g. The average pore diameter and specific surface area of the carbonaceous material are set in the above-mentioned ranges to effectively prevent accumulation of PCBs, particularly, non-ortho-Co-PCBs and mono-ortho-Co-PCBs, more particularly mono-ortho-Co-PCBs in the living body that has taken in the food of the present invention. The average pore diameter and specific surface area of the carbonaceous material can be adjusted to be within the above-mentioned ranges by controlling the conditions of activation treatment to the carbonaceous material.

In this case, the average pore diameter of the carbonaceous material is measured by a t-plot method and formally expressed in a unit of (2t)/nm. The specific surface area of the carbonaceous material is one measured by a BET method by nitrogen gas adsorption.

Calcium is bound to the above-mentioned carbonaceous material in the following manner. First, an aqueous calcium chloride solution is added to a carbonaceous material and the resultant is mixed uniformly. Then, the solution is heated to evaporate the water. In order to prevent combustion of carbonaceous material, the thus-treated carbonaceous material is heated at 150 to 300° C., preferably 160 to 200° C. for about 60 to 120 minutes in a poor oxygen environment or oxygen-free environment. This causes dehydration reaction to proceed, thus providing a carbonaceous material having calcium bound mainly to the inside of the pores. In this case, if the heating temperature is less than 150° C., the dehydration reaction proceeds with difficulty, so there is a possibility that the desired carbonaceous material having calcium bound thereto cannot be obtained. On the contrary, if the heating temperature is more than 300° C., the binding construction between carbon and calcium in the carbonaceous material is broken, so there is a possibility that the desired carbonaceous material having calcium bound thereto cannot be obtained.

Here, a binding amount of calcium of the carbonaceous material can be controlled by adjusting a mixing ratio of the carbonaceous material to the aqueous calcium chloride solution while taking into consideration the concentration of the aqueous calcium chloride solution. In general, the binding amount of calcium to the carbonaceous material is preferably set to 2.0 to 10 g of calcium per 100 g of carbonaceous material. If the amount of calcium is less than 2.0 g, the resultant carbonaceous material may be an insufficient adsorbability for PCBs. On the contrary, if the amount of calcium is more than 10 g, calcium tends to be laminated on the surface of the carbonaceous material, so there is a possibility that the resultant carbonaceous material will have a decreased adsorbability for dioxins.

The binding amount of calcium can be confirmed, usually, by a cation exchange capacity measuring method.

In the food of the present invention, it is preferable that the content ratio of the carbonaceous material be usually set to 0.1 to 1.0 wt %. If the content ratio of the carbonaceous material is 0.1 wt % or less, there is a possibility that the food of the present invention may exhibit the effects with difficulty described below. On the contrary, if the content ratio of the carbonaceous material is more than 1.0 wt %, there is a possibility that the feeling of eating or savor of the feed stuff may be deteriorated and effects proportional to the content ratio is difficulty obtain while the resultant food becomes expensive, and thus the content ratio of more than 1.0 wt % is uneconomical.

The food of the present invention can be produced by adding the above-mentioned carbonaceous material to the above-mentioned feedstuff and mixing them. On this occasion, the carbonaceous material may be mixed with the feeds tuff either as it is or in a state in which the carbonaceous material is dispersed in water (for example, in the form of slurry).

The food of the present invention can adsorb trace amounts of dioxins contained therein by the carbonaceous material contained therein. In particular, because the carbonaceous material has calcium bound thereto, it is excellent in adsorbability not only for PCDDs and PCDFs but also for PCBs. This would be because dioxins such as PCBs have a negative charge due to chloride ions whereas the carbonaceous material having calcium bound thereto usually has a positive charge, so the dioxins tend to be attracted by the carbonaceous material and adsorbed thereon. As a result, when the food is taken in by an animal inclusive of a human, the dioxins contained in the feedstuff and the dioxins accumulated in the body, particularly in digestive system, which include PCBs, are effectively adsorbed by the carbonaceous material and the carbonaceous material having adsorbed thereon the dioxins inclusive of PCBs is excreted out of the living body together with the excrement.

Therefore, the food of the present invention causes dioxins inclusive of PCBs to be difficulty accumulated in the living body and also exhibits the function of excreting the dioxins inclusive of PCBs already accumulated in the living body to the outside of the body. As a result, the food of the present invention can prevent accumulation of dioxins inclusive of PCBs in the living body.

The food of the present invention is a functional food having such a function and thus can be used as a processed food for humans or a feed for cultured fishes and shellfishes, poultry or domestic animals.

In a case where the food of the present invention is used as a feed for cultured fishes and shellfishes, poultry or domestic animals, for example, the cultured fishes and shellfishes, poultry or domestic animals can be cultivated or bred by being continuously fed the food of the present invention. On this occasion, as for the cultivated or bred organisms, dioxins inclusive of PCBs are hardly accumulated in the body due to the function of the food of the present invention. That is, the cultured fishes and shellfishes, poultry or domestic animals cultivated or bred on the food of the present invention as a feed have a considerably decreased content of dioxins inclusive of PCBs as compared with the cultured fishes and shellfishes, poultry or domestic animals cultivated or bred on a normal feed. Therefore, the cultured fishes and shellfishes, poultry or domestic animals cultivated or bred on the food of the present invention can serve as a food for humans that is much safer than those cultivated or bred on a usual feed.

### EXAMPLE

### Examples 1 to 6

In a container having an inner volume of 500-ml, 5 g of a carbonaceous material shown in Table 1 was charged and 200 ml of a 2 wt % aqueous calcium chloride solution was added thereto, followed by stirring at room temperature for 60 minutes. Subsequently, water was added to the container to wash it to remove excessive calcium and separate the carbonaceous material. The separated carbonaceous material was transferred into a glass flask having an inner volume of 500 ml and stirred therein using a stirrer equipped with a temperature adjusting function while heating to evaporate the water. Then, the carbonaceous material was heated at 160° C. for 90 minutes under a poor oxygen environment. This afforded about 5 g of a calcium-bound carbonaceous material. The calcium binding amount of about 5 g of the obtained calcium-bound carbonaceous material was as shown in Table 1.

On the other hand, dioxins (total 10 pg of PCDDs and PCDFs, mixture of 10 pg of non-ortho-Co-PCBs and 10 pg of mono-ortho-Co-PCBs) were added to a commercially available feed for rat to make a content per g of the feed 30 pg to prepare dioxins-containing feeds. Then, the calcium-bound carbonaceous material was added to the dioxins-containing feeds in ratios shown in Table 1 and uniformly mixed to prepare carbonaceous material-containing feeds.

### Comparative Example 1

Dioxins (total 10 pg of PCDDs and PCDFs, mixture of 10 pg of non-ortho-Co-PCBs and 10 pg of mono-ortho-Co-PCBs) were added to a commercially available feed for rat to make a content per g of the feed 30 pg to prepare dioxins containing feeds. Then, the carbonaceous material shown in Table 1 was added to the dioxins-containing feeds in the ratios shown in Table 1 and uniformly mixed to prepare carbonaceous material-containing feeds.

TABLE 1

| | | Carbonaceous | | | | Content of |
|---|---|---|---|---|---|---|
| | | Material | | Specific | Calcium | carbonaceous |
| | | (Trade name: | Average pore | surface | binding | material in |
| | | manufacturer's name | diameter | area | amount | feed |
| | | in the brackets) | ((2t)/nm) | (m²/g) | (g) | (wt %) |
| Example | 1 | ACF A-7 | 0.68 | 920 | 0.10 | 1.0 |
| | | (Osaka Gas Chemical | | | | |
| | | Co., Ltd.) | | | | |
| | 2 | G1 | 0.91 | 2,013 | 0.11 | 0.1 |
| | | (Mitsubishi Chemical | | | | |
| | | Calgon Co., Ltd.) | | | | |
| | 3 | 6MD | 0.72 | 983 | 0.45 | 1.0 |
| | | (Mitsubishi Chemical | | | | |
| | | Calgon Co., Ltd.) | | | | |
| | 4 | F300D | 0.70 | 1,121 | 0.30 | 0.4 |
| | | (Mitsubishi Chemical | | | | |
| | | Calgon Co., Ltd.) | | | | |
| | 5 | SA SUPER DD | 0.81 | 1,124 | 0.29 | 0.7 |
| | | (Nippon Norit Co., | | | | |
| | | Ltd.) | | | | |
| | 6 | Carboxen 1012 | 0.70 | 1,558 | 0.25 | 0.1 |
| | | (U.S. Spelco Co.) | | | | |

| | | | | | |
|---|---|---|---|---|---|
| Comparative | Taikou S (Futamura | 1.14 | 1,745 | 0 | 0.1 |
| Example 1 | Chemical Co., Ltd.) | | | | |

### Evaluation

Three rats were fed by being fed one of the carbonaceous material-containing feeds obtained in each of Examples 1 to 6 and Comparative Example 1 for 90 days. In this case, the amount of the carbonaceous material fed was set to a total of 900 g per rat.

Each rat after 90 days from the start of the feeding was examined for the amount of dioxins accumulated in the body. In this case, the rat was killed and its total body was homogenized. Then, a total amount of dioxins contained in the rat, that is, the amount of dioxins accumulated in the rat was obtained according to the dioxins measuring method described in “Manual for Examining Dioxins Accumulation in Wild Organisms” (published by JAPAN WILDLIFE Research Center, Foundation, on September 2002). Then, absorption rate of dioxins taken in by each rat ((amount of accumulated dioxins)+(total amount of dioxins taken in from food)×100) was calculated. The results are shown in Table 2. The amount of accumulated dioxins and absorption rate of dioxins shown in Table 2 are average values of three rats.

TABLE 2

| | | Total | | | | | | |
|---|---|---|---|---|---|---|---|---|
| | | amount of | | | | | | |
| | | dioxins | Non-ortho-Co-PCBs | | Mono-ortho-Co-PCBs | | PCDDs and PCDFs | |
| | | taken in | Accumulation | Absorption | Accumulation | Absorption | Accumulation | Absorption |
| | | from food | amount | rate | amount | rate | amount | rate |
| | | (pg) | (pg) | (%) | (pg) | (%) | (pg) | (%) |
| Example | 1 | 27,000 | 1,800 | 6.7 | 14,000 | 51.9 | 1,900 | 7.0 |
| | 2 | 27,000 | 1,500 | 5.6 | 15,000 | 55.6 | 2,100 | 7.8 |
| | 3 | 27,000 | 320 | 1.2 | 3,900 | 14.4 | 490 | 1.8 |
| | 4 | 27,000 | 350 | 1.3 | 3,400 | 12.6 | 700 | 2.6 |
| | 5 | 27,000 | 320 | 1.2 | 4,700 | 17.4 | 400 | 1.5 |
| | 6 | 27,000 | 680 | 2.5 | 7,100 | 26.3 | 1,400 | 5.2 |

| | | | | | | | |
|---|---|---|---|---|---|---|---|
| Comparative | 27,000 | 7,500 | 27.8 | 25,000 | 92.6 | 1,400 | 5.2 |
| example 1 | | | | | | | |

Table 2 indicates that rats fed with the carbonaceous material-containing feeds of Comparative example 1 showed a very high absorption rate for PCBs, in particular, for mono-ortho-Co-PCBs, so large amounts of mono-ortho Co-PCBs were accumulated in the body. Whereas the rats fed with the carbonaceous material-containing feeds of Examples 1 to 6 had much reduced accumulation amounts of PCBs in the body as compared with the rats fed with the carbonaceous material-containing feeds of Comparative Example 1. In particular, rats fed with the feeds containing the carbonaceous materials having average pore size and specific surface area within the predetermined ranges showed drastic decreases in accumulation amounts of non-ortho Co-PCBs and mono-ortho Co-PCBs. As a result of this, the feeds containing the carbonaceous material having calcium bound thereto can effectively inhibit accumulation of dioxins, i.e., PCBs, PCDDs, and PCDFs in the body of rats.

The present invention can be embodied in various forms without departing from the spirit and major characteristics thereof. Therefore, the above-mentioned embodiments or examples are in any respect merely illustrative and should not be construed as being limitative. The scope of the present invention is indicated by claims and is not restricted by the body of the specification. Further, variations and modifications that belong to equivalents of the scope of claims are all within the scope of the present invention.

What is claimed is:

1. A food containing a carbonaceous material, comprising:
a pore structure capable of exhibiting adsorbability; and
calcium bound thereto.

2. A food according to claim 1, wherein the carbonaceous material has an average pore diameter of 0.70 to 0.90 nm and a specific surface area of 950 to 1,600 m²/g.

3. A method of cultivating fish and shellfish, comprising a process of feeding a food containing a carbonaceous material that has a pore structure capable of exhibiting adsorbability and to which calcium is bound.

4. A breeding method of poultry, comprising a process of feeding a food containing a carbonaceous material that has a pore structure capable of exhibiting adsorbability and to which calcium is bound.

5. A breeding method of domestic animals, comprising a process of feeding a food containing a carbonaceous material that has a pore structure capable of exhibiting adsorbability and to which calcium is bound.
